(19) United States
(12) Patent Application Publication
(10) Pub. No.: US 2001/0023178 A1
(43) Pub. Date: Sep. 20, 2001

(54) Mobile communication station and its associated antenna

(76) Inventors: Takashi Amano, Soka-shi (JP); Norimichi Chiba, Hino-shi (JP); Hisao Iwasaki, Tama-shi (JP); Shuichi Sekine, Yokohama-shi (JP); Noriaki Odachi, Yokohama-shi (JP); Hiroyuki Dai, Musashino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/739,206

(22) Filed: Dec. 19, 2000

(30) Foreign Application Priority Data
Dec. 20, 1999 (JP) 11-360539
Aug. 31, 2000 (JP) 2000-262330

(51) Int. Cl. H04B 1/38

(52) U.S. Cl. 455/83; 455/129; 455/107; 455/575; 455/296; 343/702

(57) ABSTRACT

A antenna of a mobile station is composed of a first antenna section having a helical section and a first contact and a rod-like second antenna section coupled at its one end to the first contact and having a second contact at the other end. When the second antenna section is housed in the casing, the first contact comes to face the internal surface of a feeding terminal with the result that it is capacitive-coupled with a matching circuit. When the second antenna section is pulled out of the casing, the second contact comes in direct contact with the feeding terminal with the result that it is directly connected to the matching circuit. Thereby, the band of resonant frequencies when the antenna is housed in the casing is widened and the antenna gain when the antenna is pulled out of the casing is improved.

### CROSS-REFERENCE TO RELATED APPLICATIONS

This application is based upon and claims the benefit of priority from the prior Japanese Patent Applications No. 11-360539, filed Dec. 20, 1999; and No. 2000-262330, filed Aug. 31, 2000, the entire contents of which are incorporated herein by reference.

### BACKGROUND OF THE INVENTION

The present invention relates to a mobile station in a mobile communication system and an antenna for use with the mobile station.

Mobile stations used in mobile communication systems are each equipped with an antenna for communicating with base stations via radio-frequency signals. The mainstream of such an antenna is in a type that can be housed in a casing in order to effect a reduction in the size of the mobile station. In order to enhance the sensitivity to electromagnetic waves from base stations, particularly even in the state where the antenna is housed in the casing, antennas have normally been used which are constructed in the following way:

The antenna consists of a first antenna section that is formed helically and a second antenna section that is joined in the direction of its length with the first section. The first section has a first contact and the second section has a second contact. When the antenna is housed, that is, when the second section is housed in the casing, the first contact is brought into contact with the feeding point in the casing and the first antenna section is therefore fed. On the other hand, when the antenna is extended, that is, when the second section is pulled out of the casing, the second contact is brought into contact with the feeding point with the result that the second section is supplied with power. Constructing the antenna in this way allows signals from base stations to be received regardless of whether the antenna is housed or extended. Particularly when the antenna is housed, only the helical section, or the first antenna section, protrudes from the casing, making the mobile station easy to carry.

When a user puts a mobile station in a bag or a breast pocket of his or her coat or on a desk, the antenna is frequently housed in the casing. When the mobile station is put in a bag or a breast pocket or on a desk with the antenna housed in the casing, a variation occurs in the impedance of the antenna and consequently in its resonant frequency characteristic, making electromagnetic waves from base stations difficult to capture. With an antenna of such a type as is brought into contact with the feeding point regardless of whether it is housed in the casing or pulled out of the casing as described above, the problem of variations in the resonant frequency characteristic when the antenna is housed cannot be eliminated.

Another type of antenna is one in which the antenna and the feeding point are capacitive-coupled with each other regardless of whether the antenna is housed in or pulled out of the casing. This type of antenna has a stable resonant frequency characteristic when it is housed in the casing. However, the capacitive coupling results in reduced mechanical length of the antenna, which in turn leads to a reduction in the length of that portion of the antenna which protrudes from the casing; thus, the antenna gain cannot be set high. The demand cannot therefore be met for increasing the antenna gain by pulling the antenna out of the casing in order to make the quality of communication as good as possible during communication.

### BRIEF SUMMARY OF THE INVENTION

As described above, with the conventional antenna associated with a mobile station, it is impossible to simultaneously solve a problem of difficulty in capturing electromagnetic waves from base stations when it is housed in the casing, which results from its resonant frequency characteristic varying with environments in which the mobile station is placed, and a problem of difficulty in obtaining high antenna gain even when it is pulled out of the casing.

It is therefore an object of the present invention to provide a mobile station and its associated antenna which permits the band of resonant frequencies when the antenna is housed in the casing to be widened and the antenna gain when the antenna is pulled out of the casing to be improved.

According to an aspect of the present invention, there is provided an antenna for use with a mobile station including a casing to which the antenna is attached, a radio-frequency circuit for transmitting and receiving radio-frequency signals through the antenna, a matching circuit for providing impedance matching between the radio-frequency circuit and the antenna, and a feeding terminal connected to the matching circuit for feeding the antenna, comprising: a first antenna section having a helical portion and a first contact electrically connected with the helical portion; and a rod-like second antenna section having its one end coupled with the first contact and provided at the other end with a second contact, when the second antenna section is enclosed in the casing of the mobile station, the first contact faces the feeding terminal with space interposed between the first contact and the feeding terminal and is capacitive-coupled with the matching circuit, and when the second antenna section is pulled out of the casing, the second contact contacts the feeding terminal and the second contact is directly coupled with the matching circuit.

According to another aspect of the present invention there is provided a mobile station including a casing to which an antenna is attached; a radio-frequency circuit for transmitting and receiving radio-frequency signals through the antenna, a matching circuit for providing impedance matching between the radio-frequency circuit and the antenna, and a feeding terminal connected to the matching circuit for feeding the antenna, the antenna comprising: a first antenna section having a helical portion and a first contact electrically connected with the helical portion; and a rod-like second antenna section having its one end coupled with the first contact and provided at the other end with a second contact, when the second antenna section is enclosed in the casing of the mobile station, the first contact faces the feeding terminal with space interposed between the first contact and the feeding terminal so that it is capacitive-coupled with the matching circuit, and when the second antenna section is pulled out of the casing, the second contact contacts the feeding terminal so that the second contact is directly coupled with the matching circuit.

According to still another aspect of the present invention there is provided an antenna for use with a mobile station including a casing to which the antenna is attached, a radio-frequency circuit for transmitting and receiving radio-frequency signals through the antenna, and a feeding terminal connected to the radio-frequency circuit for feeding the antenna, comprising: a fixed antenna section fixed to protrude from the casing and having a first helical section and a second helical section with a helical center line which are arranged along the helical center line and are opposed to each other at their one end so that they are capacitive-coupled, one end of the first helical section on the opposite side from the second helical section being connected with the feeding terminal; a rod antenna section including a metallic rod portion and a resin rod portion that are coupled together in a line, the rod antenna section being movable into or out of the casing along the helical center line of the first and second helical sections, the resin rod portion being opposed to the first helical section when the metallic rod portion is received within the casing, and an end portion of the metallic rod portion being electrically connected to an end portion of the first helical section when the metallic rod portion is pulled out from the casing.

According to a further aspect of the present invention there is provided a mobile station including a casing to which an antenna is attached; a radio-frequency circuit for transmitting and receiving radio-frequency signals through the antenna, and a feeding terminal connected to the radio-frequency circuit for feeding the antenna, the antenna comprising: a fixed antenna section fixed to protrude from the casing and having a first helical section and a second helical section with a helical center line which are arranged along the helical center line and are opposed to each other at their one end so that they are capacitive-coupled, one end of the first helical section on the opposite side from the second helical section being connected with the feeding terminal; a rod antenna section including a metallic rod portion and a resin rod portion that are coupled together in a line, the rod antenna section being movable into or out of the casing along the helical center line of the first and second helical sections, the resin rod portion being opposed to the first helical section when the metallic rod portion is received within the casing, and an end portion of the metallic rod portion being electrically connected to an end portion of the first helical section when the metallic rod portion is pulled out from the casing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows a mobile station and its associated antenna of a first embodiment of the present invention in a state where the second antenna section is housed in the mobile station casing;

FIG. 2 shows a state where the second antenna section is pulled out of the casing in the first embodiment;

FIG. 3 shows the position relationship between the first contact and the feeding point in FIG. 1;

FIG. 4 shows the position relationship between the second contact and the feeding point in FIG. 1;

FIGS. 5A and 5B show the return loss versus frequency characteristic of the antenna when the second antenna section is housed in the casing in the first embodiment;

FIGS. 6A and 6B show the antenna gain in a state where the second antenna section is merely pulled out of the casing in the first embodiment;

FIGS. 7A and 7B show the antenna gain in a state where the second antenna section is pulled out of the casing for the purpose of communication in the first embodiment;

FIGS. 8A and 8B show a mobile station and its associated antenna of a second embodiment of the present invention in a state where the second antenna section is pulled out of the mobile station casing and an equivalent circuit thereof;

FIG. 9 shows a mobile station and its associated antenna of a third embodiment of the present invention in a state where the second antenna section is housed in the mobile station casing;

FIG. 10 shows a state where the second antenna section is pulled out of the casing in the third embodiment;

FIG. 11 shows a mobile station and its associated antenna of a fourth embodiment of the present invention in a state where the rod antenna section is pulled out of the mobile station casing;

FIG. 12 shows a state where the rod antenna section is housed in the casing in the fourth embodiment;

FIGS. 13A and 13B show the return loss versus frequency characteristic of the antenna when the rod antenna section is pulled out of the casing in the fourth embodiment; and

FIGS. 14A and 14B show the return loss versus frequency characteristic of the antenna when the rod antenna section is housed in the casing in the fourth embodiment.

### DETAILED DESCRIPTION OF THE INVENTION

### First Embodiment

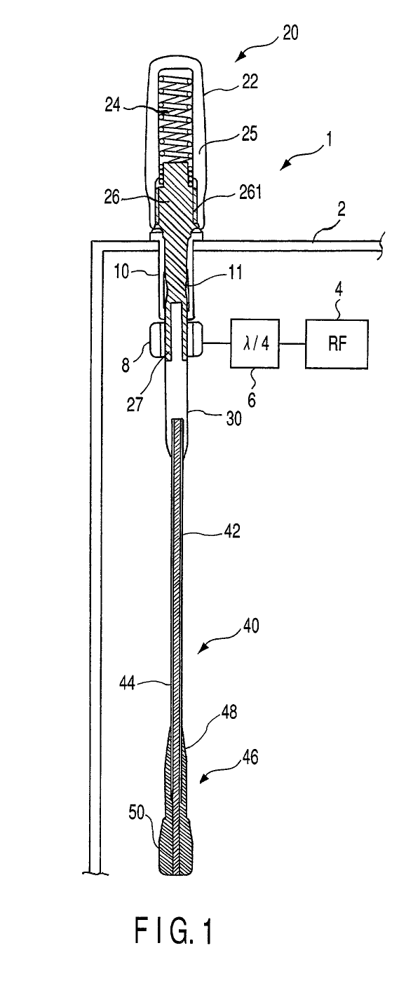

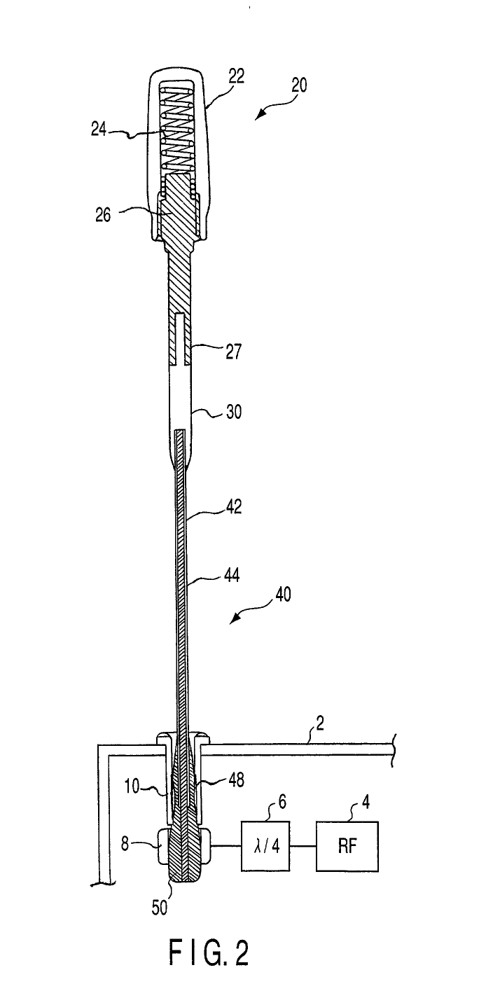

FIGS. 1 and 2 show a mobile station and an antenna according to a first embodiment of the present invention. More specifically, FIG. 1 shows the state where a portion of the antenna 20 is housed in the casing 1 of the mobile station 1 and FIG. 2 shows the state where the portion of the antenna 20 is pulled out of the casing.

As shown in FIG. 1, there is provided in the casing 2 of the mobile station 1 an RF circuit 4 for transmitting and receiving radio-frequency signals. The RF circuit 4 has its input/output terminal connected to a matching circuit 6, which is made of a line pattern substrate having a length of one-quarter the wavelength in use. The matching circuit may be implemented by inductance or capacitance as in conventional ones.

The input/output terminal of the matching circuit 6 is connected to a feeding terminal 8 of U-shaped cross section. In the present invention, a point is the relationship between the inside dimension of the feeding terminal 8 and the diameter of the contact of the antenna 20, which will be described in detail later.

A sleeve-shaped (tube-shaped) holder 10 is screwed to the casing 2. The holder 10 is adapted to hold the antenna 20 movably up and down, i.e., along the direction of the length of the antenna. The holder 10 is provided on its inside surface with a spring member 11 formed by curving a sheet metal in order to hold the antenna firmly. The feeding terminal 8 is placed below the holder 10 so that the antenna 20 is movable in the U-shaped portion.

The antenna 20 is provided with a first antenna section 22 functioning as a helical antenna and a second antenna section 40 functioning as a rod antenna, which are mechanically joined with each other by a non-metallic rod member 30 along the length of the antenna. That is, the first antenna section 22 and the second antenna section 40 are not electrically connected.

The first antenna section 22 consists of a helical section 24 made of a metallic wire shaped into a helical form and a metal rod member 26 having its one end electrically connected with the end of the helical section 24. Specifically, the lower portion of the helical section 24 is wound onto the upper portion of the rod member 26 as shown.

The outside diameters of the upper and the lower portion of the metallic rod member 26 are respectively set greater than and approximately equal to the inside diameter of the holder 10. The lower portion of the rod member 26 is set greater in length than the holder 10. Thereby, when the antenna is housed in the casing 2, only the lower portion of the rod member 26 is fitted into the holder 10 and then held by force of the spring member 11. At this point, the lower end of the rod member 26 protrudes from the holder 10 into the U-shaped portion of the feeding terminal 8. That is, this portion of the rod member 26 functions as a first contact 27. In addition, the lower end of the rod member 26 is formed in the shape of a sleeve into which one end of the joining rod member 30 is press fitted. Thus, the first antenna section 22 and the rod member 30 are joined mechanically with each other.

A plastic cap 25 is put on the first antenna section 22 so as to cover the helical section 24 and the upper portion of the metallic rod member 26. The cap 25 is fixed to the rod member 26 by welding or screwing. The portion covered with the cap 25 forms that portion of the antenna which protrudes from the casing 2 in a state where the antenna is housed in the casing 2.

The second antenna section 40 has an antenna conductor 42 which is press fitted into an insulating tube 44 except its lower portion. The lower portion of the antenna conductor 42 is press fitted into a stopper 46 made of a metal and fixed by caulking. That is, the antenna conductor 42 and the stopper 46 are electrically connected together.

The outside diameter of the upper portion of the stopper 46 is set substantially equal to the inside diameter of the holder 10 and that upper portion of the stopper functions as an antenna holding section 48. That is, when the antenna is extended, the antenna holding section 48 is inserted into the holder 10 and held by the spring member 11. The outside diameter of the lower portion of the stopper 46 is set greater than that of the antenna holding section 48 and substantially equal to the inside diameter of the feeding terminal 8. That lower portion of the stopper functions as a second contact 50. That is, when the antenna is extended, the lower portion of the stopper 46, or the second contact 50 is fitted into the feeding terminal 8 and electrically connected thereto.

The rod member 30 has a hole formed at its one end on the opposite side from the first antenna section 22, into which the antenna conductor 42 of the second antenna section 40 is press fitted. Thereby, the rod member 30 and the second antenna section 40 are mechanically joined together.

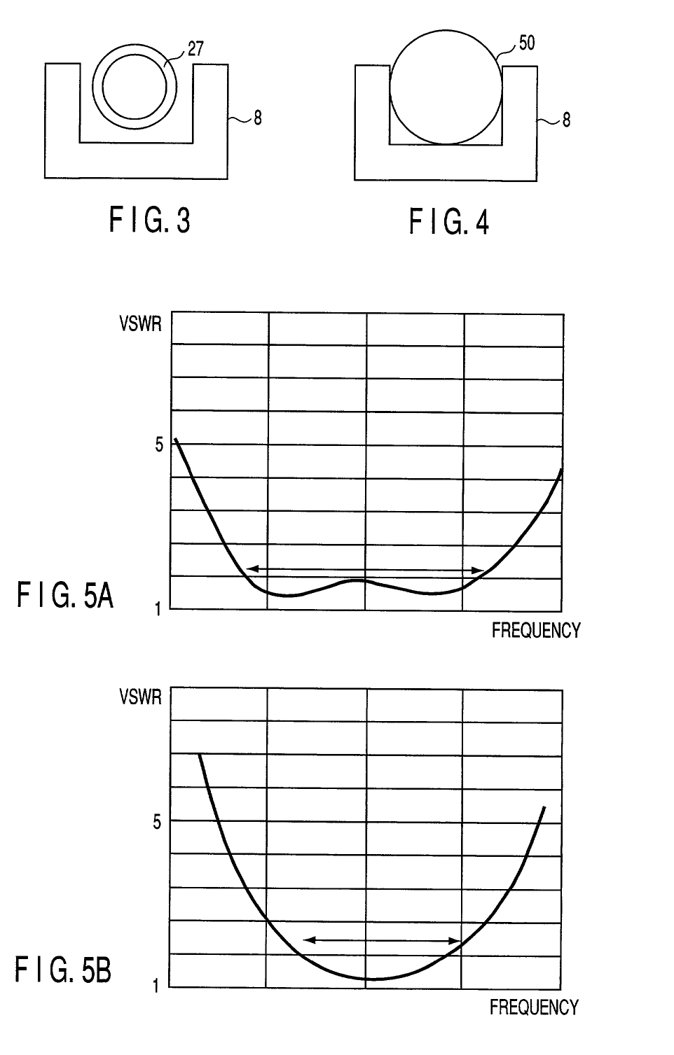

Reference will now be made to FIGS. 3 to 7 to describe the electrical properties of the antenna 20 thus constructed when it is housed in the casing and pulled out of the casing.

When the second antenna section 40 is housed in the casing 2, the first contact 27 protrudes from the holder 10 and comes to face the U-shaped feeding terminal 8 with space interposed there between as shown in FIG. 3. In this state, the first antenna section 22 having the first contact 27 is capacitive-coupled with the feeding terminal 8. The first antenna section 22 is set to have a mechanical length of less than ½ wavelength in order to set the sum of the electrical length based on the capacitive component and its electrical length equal to ½ wavelength. As a result, when the antenna is housed, the coupling capacitive component produced in the feeding part and the first antenna section 22 come to function as a half-wave antenna as viewed from the matching circuit 6.

When the second antenna section 40 is pulled out of the casing 2, the second antenna 40 is fed from the feeding terminal B. In this state, the second antenna section 40 comes into direct contact with the feeding terminal 8 as shown in FIG. 4, so that no capacitive component exists. For this reason, the first antenna section 40 is set to have a mechanical length of ½ wavelength. As a result, when the antenna is extended, the second antenna section 40 by itself comes to function as a half-wave antenna as viewed from the matching circuit 6.

The properties of the antenna when it is housed in the casing will be described with reference to FIGS. 5A and 5B. FIG. 5A shows the return loss characteristic (VSWR versus frequency characteristic) when the first contact 27 of the first antenna section 22 is capacitive-coupled with the feeding terminal 8, i.e., the former is not in contact with the latter. FIG. 5B shows the return loss characteristic which would result if the first contact 27 and the feeding terminal 8 were brought into direct contact with each other. The return loss characteristic represents that the lower the VSWR value, the easier it is to capture electromagnetic waves.

As described previously, the first contact 27 of the first antenna section 22 is capacitive-coupled with the feeding terminal 8 when the antenna is housed in the casing. As a result, the first antenna section 22 is connected to the matching circuit 6 through capacitive-coupling, in which case such a return loss characteristic as shown in FIG. 5A results. If the first contact 27 and the feeding terminal 8 are brought into direct contact with each other under the same conditions, such a characteristic as shown in FIG. 5B will result.

Comparison of FIG. 5A with FIG. 5B shows that, when the first antenna section 22 is capacitive-coupled with the matching circuit 6, the frequency range in which the return loss is low, i.e., the band of frequencies at which the antenna exhibits resonance, becomes wider than with direct coupling. This is due to extension of the band of resonant frequencies resulting from the matching circuit acting separately on capacitive-coupling-based resonant frequencies and on first antenna section-based resonant frequencies. Thus, the band of frequencies that can be transmitted and received is widened and it becomes possible to receive electromagnetic waves from base stations even in environments, such as bags, pockets, etc., in which the mobile station is put and the antenna impedance is subject to variation.

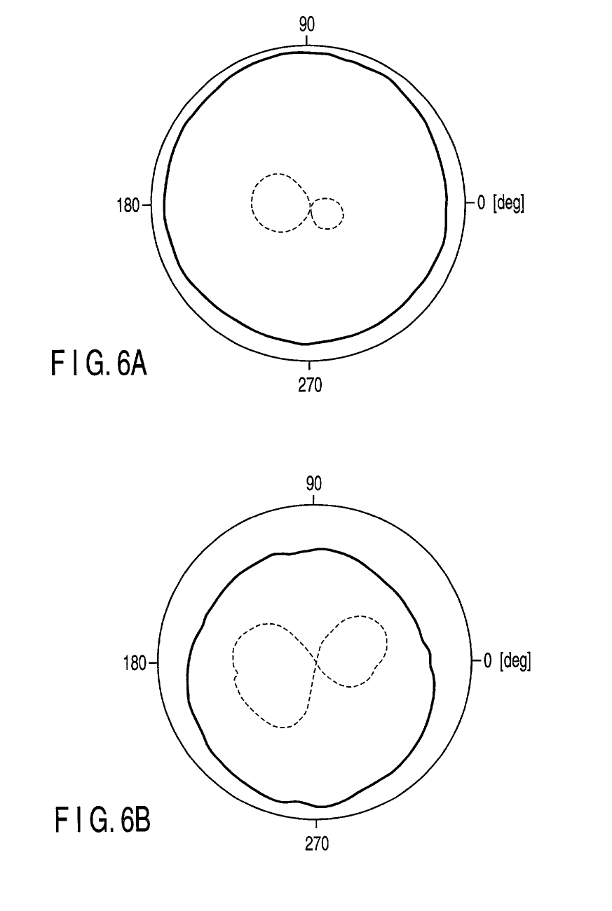

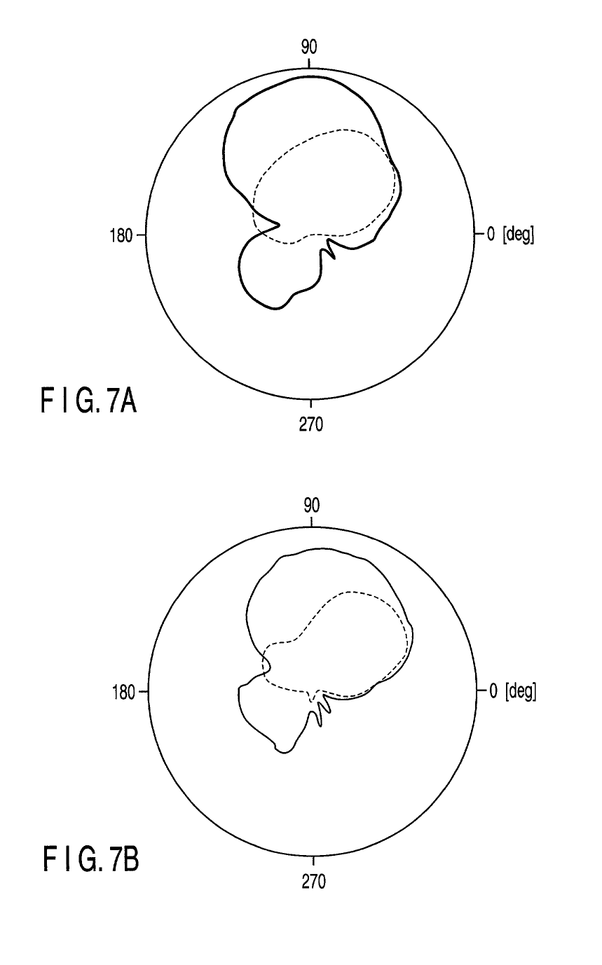

Next, the properties of the antenna when it is extended will be described with reference to FIGS. 6A, 6B, 7A, and 7B.

FIGS. 6A and 6B show the antenna gain when the mobile station 1 is placed with the antenna 20 extended perpendicular to the horizontal plane. More specifically, FIG. 6A shows the antenna characteristic when the second contact 50 and the feeding terminal 8 are in direct contact with each other, and FIG. 6B shows the characteristic which would result if the second contact 50 and the feeding terminal 8 were capacitive-coupled. In these figures, solid lines represent the gain for major polarized waves, whereas dotted lines represent the gain for intersecting polarized waves. The further away the line is from the center, the greater the gain is.

When the antenna is extended, i.e., when the second antenna section 40 is pulled out of the casing 2, the second contact 50 is directly connected through the feeding terminal 8 with the matching circuit 6. The antenna gain in this case is as depicted in FIG. 6A. It can therefore been seen that the antenna gain for major polarized waves is great in comparison with that in the case of capacitive coupling shown in FIG. 6B.

With antennas of capacitive-coupling type, in order to allow the rod to resonate at ½ wavelength, it is required to set the rod to be smaller than ½ wavelength in view of the effects of capacitive component. By so doing, the mechanical length of the antenna, namely, the length of that portion of the antenna which protrudes from the casing 2, is made shorter than with direct coupling. The antenna whose protruding portion is longer, namely, the direct-coupled antenna of the present embodiment, has higher gain as a result.

For communication, the mobile station is used close to the human head. The antenna gain in such a case is shown in FIGS. 7A and 7B. FIG. 7A shows the antenna characteristic when the second contact 50 is direct-coupled with the feeding terminal 8, whereas FIG. 7B shows the antenna characteristic when the second contact 50 is capacitive-coupled with the feeding terminal 8. In these figures as well, solid lines represent the gain for major polarized waves, whereas dotted lines represent the gain for intersecting polarized waves. The further away the line is from the center, the greater the gain is.

As can be seen from comparison between FIGS. 7A and 7B, even in a state where the mobile station is used in the proximity of the human head, the antenna gain for major polarized waves when the second antenna section 40 is direct-coupled with the matching circuit 6 is greater than in the capacitive coupling. That is, the sensitivity of the antenna is good.

The antenna constructed as described above provides the following workings and advantages:

(1) When the second antenna section 40 is housed in the casing 2 and the amount of antenna protrusion is thereby reduced, the first contact 27 of the first antenna section 22 comes to face the feeding terminal 8 with space therebetween. As a result, the first antenna section 22 is capacitive-coupled with the matching circuit 6; therefore, the range of resonant frequencies, that is, the band of frequencies which can be received, can be widened. Even when the mobile station 1 is placed in any place, such as in a bag or pocket or on a desk, where the antenna impedance is subject to variation, therefore, stable receiving characteristics can be obtained.

(2) It is when transmission and reception is performed that the second antenna section 40 is pulled out of the casing 2. In this case, the antenna impedance is little subject to variation in comparison with the case where the antenna is housed in the casing; thus, there is no need to consider the resonant frequency characteristic of the antenna. When the second antenna 40 is pulled out of the casing for communication, the second contact 40 is direct-coupled with the feeding terminal 8. Thereby, the mechanical length of the second antenna section 40 can be set at half the wavelength of an electromagnetic wave in use, which increases the antenna gain.

### Second Embodiment

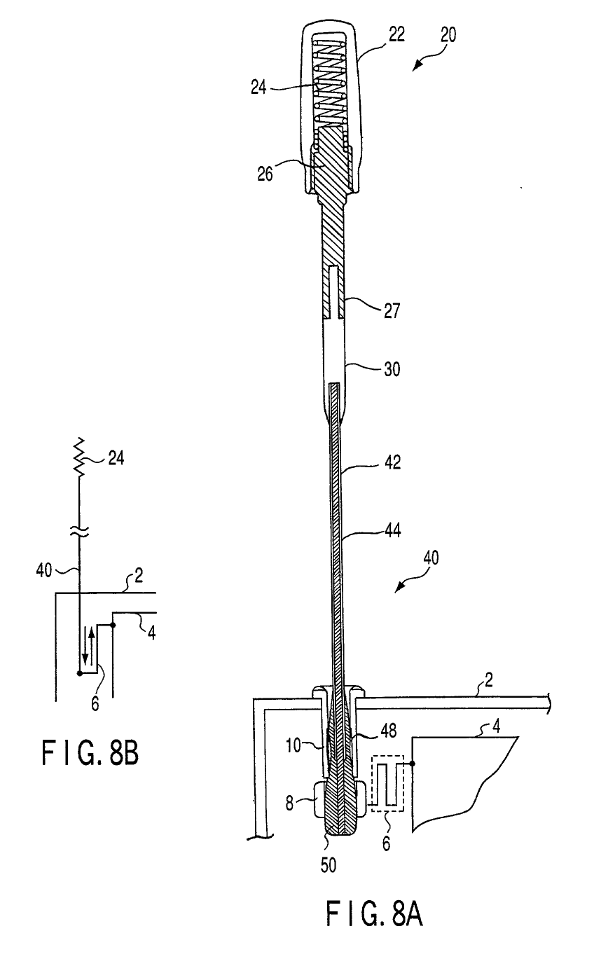

FIG. 8A shows a mobile station and its associated antenna according to a second embodiment of the present invention. FIG. 8B is a diagram for use in explanation of the principles of the part that features the second embodiment. FIG. 8A shows the extended state of the antenna. Since the features of the second embodiment are independent of the state of the antenna, a diagram illustrating the housed state of the antenna is omitted. In FIG. 8A, like reference numerals are used to denote corresponding parts to those in FIG. 2 and descriptions thereof are omitted.

As shown in FIG. 8A, the input/output terminal of the RF circuit 4 is positioned above the feeding terminal 8, i.e., on the side of the holder 10. The matching circuit 6, which is made of a substrate onto which a line having one-quarter the wavelength in use is patterned in the shape of a meander, has its one end connected to the input/output terminal of the RF circuit 4 and the other end connected to the feeding terminal 8.

Equivalently this configuration is represented as depicted in FIG. 8B. That is, in the feeding state, an exciting current is produced in the antenna 20 and the matching circuit 6 and the current in the antenna 20 and the current in the matching circuit 6 flow in parallel and in opposite directions. Therefore, radiation based on the current in the matching circuit 6 is canceled out by radiation based on the current in the antenna 20. That is, radiation from the matching circuit 6 is suppressed, which counteracts the effect of the presence of the matching circuit 6 on the antenna gain in the horizontal plane. In comparison with the case where the input/output terminal of the RF circuit 4 is positioned below the feeding terminal 8, therefore, the directivity of the antenna in the horizontal plane can be further improved. Also, the antenna gain in the horizontal plane when it is extended can be improved.

### Third Embodiment

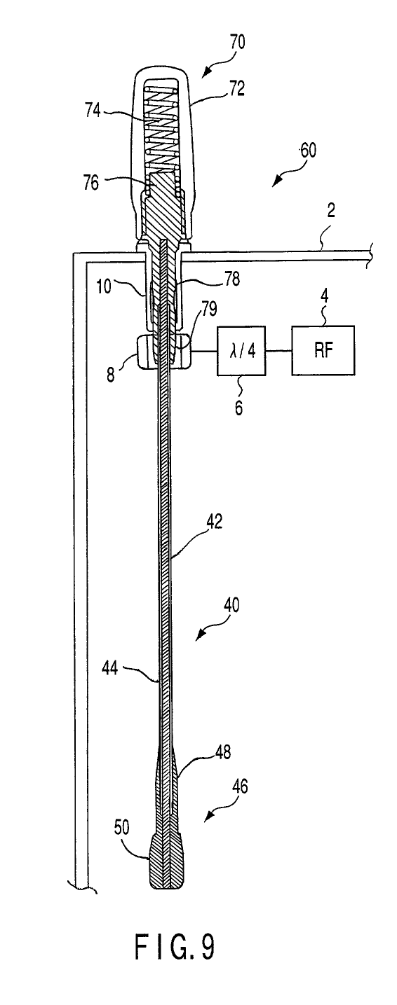

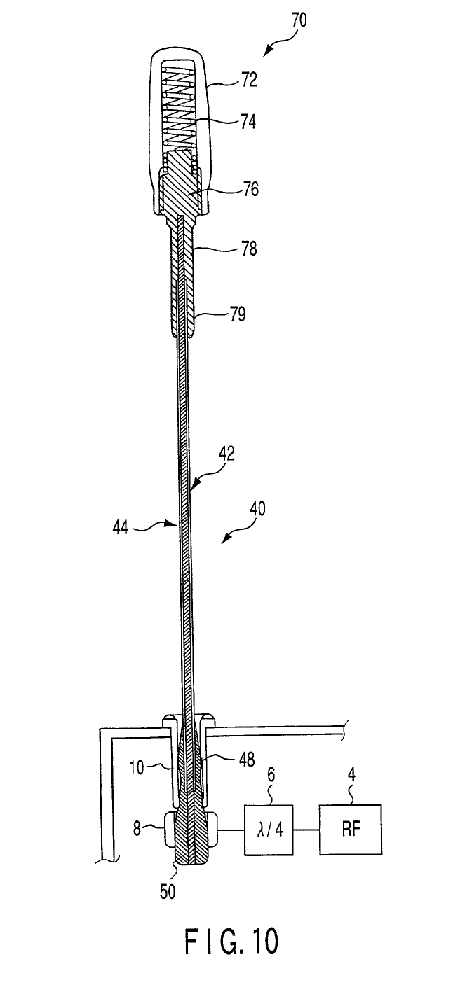

FIGS. 9 and 10 show a mobile station and its associated antenna according to a third embodiment of the present invention. More specifically, FIG. 9 shows a state where a portion of an antenna 70 is housed in the casing 2 of a mobile station 60. FIG. 10 shows a state where the portion of the antenna 70 is pulled out of the casing 2. In these figures, like reference numerals are used to denote corresponding parts to those in FIGS. 1 and 2 and descriptions thereof are omitted here.

The third embodiment differs from the first embodiment in that first and second antenna sections 72 and 40 are electrically coupled with each other. As shown in FIG. 9, the first antenna section 72 of the antenna 70 consists of a helical member 74 and a metallic rod member 76 on which the end of the helical member 74 is wound. At the end opposite the end on which the helical member 74 is wound, the rod member 76 is formed into the shape of a tube 78 into which the second antenna section 40 is fitted. The tip of the tube 78 forms a first contact 79. As in the first embodiment, the electrical length of the first antenna section 72 is set to be less than ½ wavelength by the amount corresponding to capacitive coupling between the first contact 79 and the feeding terminal 8.

The second antenna section 40, as with the first embodiment, is formed such that the antenna conductor 42 made of metal is press fitted into the insulating tube 44. However, unlike the first embodiment, the upper end portion of the antenna conductor 42 is uncovered. The upper portion of the antenna conductor 42 including the uncovered portion is press fitted into the tube portion 78 of the rod member 76 of the first antenna section 42. Thereby, the first and second antenna sections 72 and 40 are electrically connected together. Like the first embodiment, the second antenna section 40 is provided at its other end 46 with the second contact 50. Like the first embodiment, the electrical length of the second antenna section 40 is set at ½ wavelength.

When the second antenna section 40 is housed in the casing 2, the first contact 79 of the metallic rod member 76 of the first antenna section 70 is capacitive-coupled with the feeding terminal 8. This state remains unchanged from that in the first embodiment and the band of resonant frequencies can therefore be widened. In this state, as in the first embodiment, the antenna 70 is held in the casing 2 as a result of the rod member 76 of the first antenna section 72 being fitted into the holder 10.

As shown in FIG. 10, in the state where the second antenna section 40 is pulled out of the casing 2, the second contact 50 is brought into contact with the feeding terminal 8. Here, the point in which the third embodiment differs from the embodiments so far is that, when the second antenna section 40 is pulled out, not only the second antenna section 40 but also the first antenna section 72 functions as an antenna and therefore the electrical and mechanical lengths of the antenna become longer than in the first embodiment. As a result, the gain of the antenna 70 can be further improved in each of waiting and communicating states of the mobile station 60. The antenna 70 is secured to the casing 2 in the same way as in the first embodiment. More precisely, an antenna-holding section 48 fastens the antenna 70 to the holder 10 as shown in FIG. 10, thus securing the antenna 70 to the casing 2.

### Fourth Embodiment

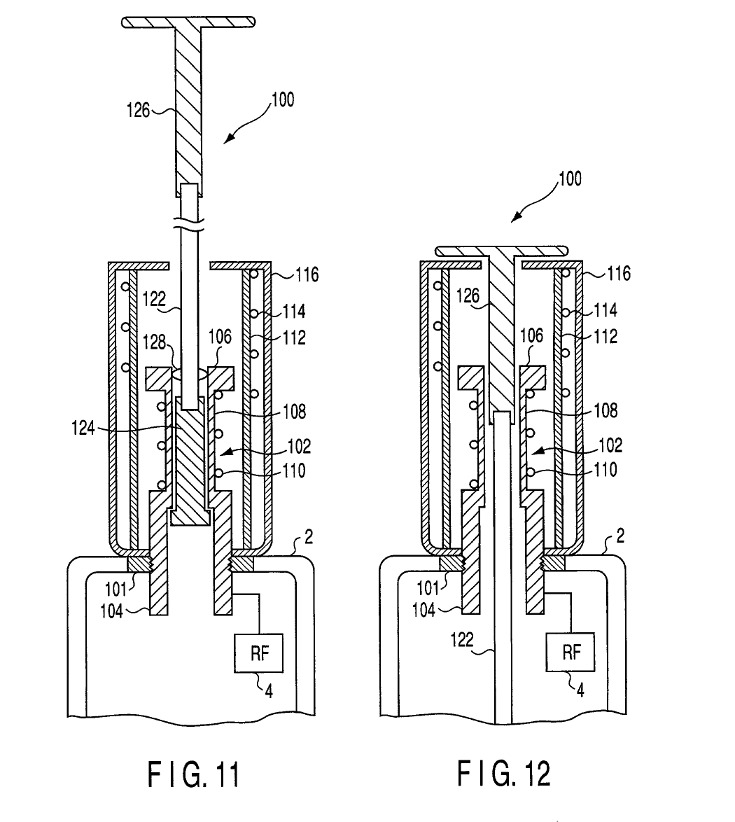

FIGS. 11 and 12 show a mobile station and its associated antenna according to a fourth embodiment of the present invention. More specifically, FIG. 11 shows a state where a portion of an antenna 100 is pulled out of the casing 2 of a mobile station 200, and FIG. 12 shows a state where the portion of the antenna 100 is housed in the casing 2.

The casing 2 of the mobile station 200 is provided with a conductive member 101 formed with a tapped hole. A holder 102, having its circumference threaded, is screwed into that conductive member 101.

The holder 102, formed by molding a resin material into the shape of a tube, comprises a feeder section 104 in the lower portion, a flange 106 in the upper portion, and a tube section 108 joining the feeder section 104 and the flange 106 together. The flange 106 and the tube section 108 are equal in inside diameter to each other but smaller than the feeder section 104. The feeder section 104 has its circumference threaded to fit the tapped hole of the conductive member 101 and plated on internal and external surfaces with metal for electrical connection with the RF circuit 4. The flange 106 is also plated on internal and external surfaces with metal. The tube section 108 is smaller in outside diameter than the feeder 104 and the flange 106 and is not plated with metal on internal and external surfaces. A conductor is helically wound on the tube section 108. This section functions as a first helical section 110. The both ends of the conductor of the first helical section 110 are electrically connected with the feeder section 104 and the flange 106, respectively.

The holder 102 has been described as the feeder section 104, the flange 106 and the tube section 108 being integrally formed from resin and the feeder section 104 and the flange 106 being with metal. Alternatively, the holder 102 may be produced by forming each of a feeder section 104 and a flange 106 separately from a conductive material and joining the feeder section 104 and the flange 106 with a tube section 108 made of resin.

The holder 102 is covered with a cap 116 made of resin which is higher than that portion of the holder 102 which protrudes from the casing 2. Inside the cap 116 is installed a tube 112 made of resin so as to cover the holder 102. A conductor is wound helically on a portion of the tube 112 above the tube section 108 of the holder 102. This portion of the tube 112 functions as a second helical section 114. The cap 116 is formed on top with a hole for receiving a rod to be described below. The cap 116 is fixed to the casing 2 using a known method.

Into the through hole of the holder 102 is inserted a rod that forms a part of antenna 100. The rod comprises a rod antenna section 122 made of a metal shaft, a guide shaft 124 for guiding the rod antenna section 122 within the holder 102, and a resin-made extension shaft 126 jointed to the top of the rode antenna section 122 for putting the rod antenna section 122 in or out of the cap 116. These members 122, 124 and 126 are joined together in a conventional way.

The rod antenna section 122 has a diameter smaller than the diameter of the through hole of the flange 106 and the tube section 108 of the holder 102 and a length of half the wavelength in use. The rode antenna section 122 is provided in its lower portion with metal projections 128 adapted to provide electrical connection with the internal surface of the flange 106 of the holder 102.

The extension shaft 126 is formed on top with a flange which, when the rod antenna section 122 is put into the casing 2, is adapted to touch the top of the cap 116 for preventing further downward movement of the rod antenna section 122. The extension shaft 126 has a diameter substantially equal to that of the through hole of the flange 106 and the tube section 108 of the holder 102 and has such a length that, when the flange touches the cap 116, it is inserted halfway into the through hole of the holder 102.

The guide shaft 124 is substantially equal in diameter to the through hole of the flange 106 and the tube section 108 of the holder 102 and is formed at bottom with a flange, which, when the rod antenna section 122 is fully pulled out, touches the top of the feeder 104 to prevent further upward movement of the rod antenna section 122. The length of the guide shaft 124 is set such that, when the rod antenna section 122 is fully pulled out, the metal projections 128 are positioned in electrical contact with the internal surface of the flange 106 of the holder 102.

The workings of the above construction will be described.

When pulled out, the rod antenna section 122 is fed through the first helical section 110 from the RF circuit 4. The first helical section 110 and the rod antenna section 122 are set in length to ¼ wavelength and ½ wavelength, respectively. Comparison with the first embodiment of FIG. 2 shows that, since the first helical section 110 and the rod antenna section 122 correspond to the matching circuit 6 and the second antenna section 40, respectively, the antenna of the second embodiment is electrically equivalent to the antenna of the first embodiment. Therefore, in the second embodiment, since the antenna can be pulled out of the casing 2 higher than in the first embodiment, the antenna gain can be further improved.

When the rode antenna section 122 is pulled out, the first helical section 110 is directly connected with the rod antenna section 122 through the flange 106 of the holder 102. At the same time, the first helical section 110 and the second helical section 114 are capacitive-coupled with each other because the upper portion of the first helical section 110 is opposed to the lower portion of the second helical section 114. The rod antenna section 110 and the second helical section 114 are made to differ in resonant frequency. By so doing, the second helical section 114 is also fed through the first helical section 110 simultaneously with the rod antenna section 122. That is, by feeding two antenna elements which differ in resonant frequency, the band of operating frequencies can be widened even when the rod antenna 122 is pulled out. Note that the length of the second helical section 114 is set to be less than ½ wavelength by the amount corresponding to capacitive-coupling.

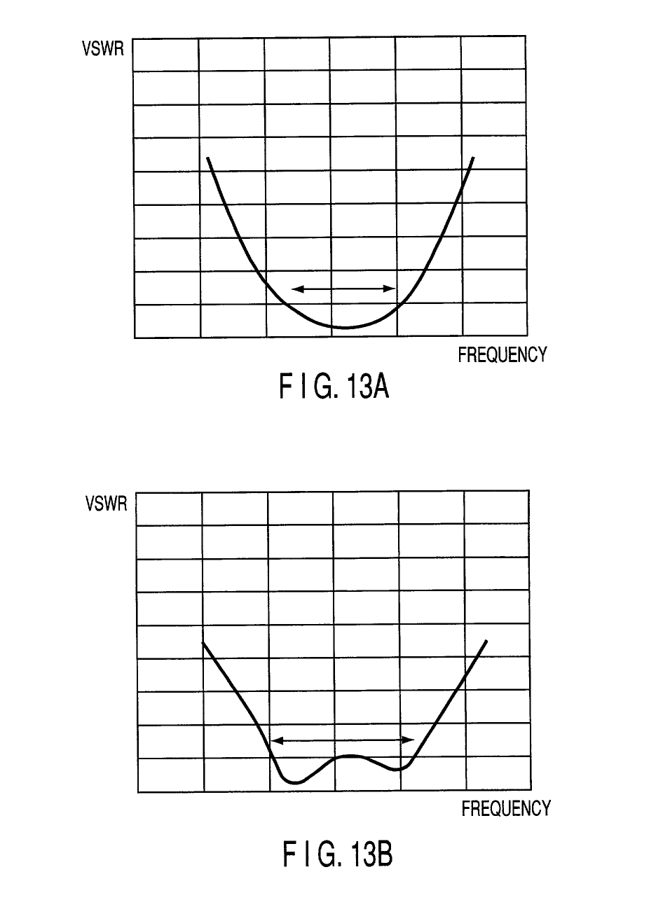

FIG. 13A shows the antenna characteristic when the first helical section 110 and the rod antenna section 122 are directly connected with each other. FIG. 13B shows the antenna characteristic when the first helical section 110 is directly connected with the rod antenna section 122 and the second helical section 114 is fed through capacitive coupling.

As can be seen from comparison of these figures, in the antenna 100 of the present embodiment, resonance based on the second helical section 114 also appears, thus allowing the band of resonant frequencies when the antenna is pulled out to be widened.

The state where the rod antenna section 122 is housed is illustrated in FIG. 12. In this state, the rod antenna section 122, which, when pulled out, was in contact with the flange 106 of the holder 102 through the metal projections 128, gets out of contact with the flange 106, with the result that the extension shaft 126 comes to face the flange 106.

Thus, when the rod antenna section 122 is housed, the second helical section 110 is fed from the RF circuit 4 through capacitive coupling with the first helical section 110. From comparison with the first embodiment of FIG. 1, it can be seen that the antenna of the present embodiment has the same electrical arrangement as when the antenna of the first embodiment is housed because the first and second helical sections 110 and 114 are made to correspond to the matching circuit 6 and the first antenna section 22, respectively. The band of resonant frequencies can therefore be widened.

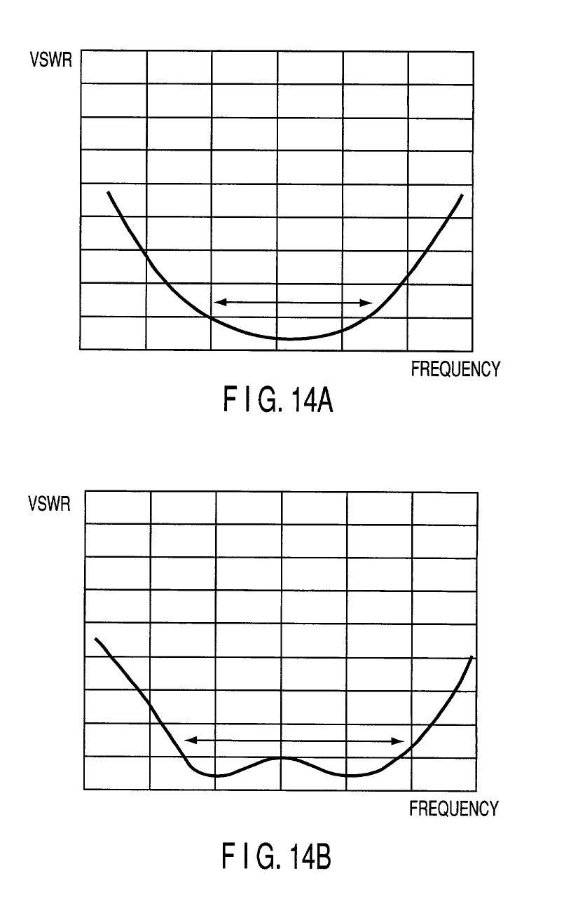

FIG. 14A shows the antenna characteristic of the first helical section 110 alone, and FIG. 4B shows the antenna characteristic when the second helical section 114 is capacitive-coupled with the first helical section 110. When the second helical section 114 is capacitive-coupled with the first helical section 110, second resonance based on the second helical section 114 appears; therefore, a wideband antenna can be obtained.

As described so far, in the first to third embodiments, when the second antenna section is housed, it gets out of contact with the feeder and comes to be capacitive-coupled with the matching circuit, thus allowing the band of resonant frequencies to be widened. Therefore, even when the mobile station is put in a place where the antenna impedance is subject to variation, such as in a bag or pocket, on a desk, etc., it can capture electromagnetic waves with ease and stability.

When the second antenna section is pulled out of the casing, it is directly fed from the feeder, which allows the antenna to be extended from the casing as high as possible and the antenna gain to be improved. The antenna and the mobile station of the present invention can achieve ease of capture of electromagnetic waves and improvement in antenna gain simultaneously.

Moreover, in the fourth embodiment, when the rod antenna section is housed, since the first helical section and the second helical section capacitive-coupled therewith are fed, the band of resonant frequencies associated with the first and second helical sections can be widened. Thus, the same advantage as in the first to third embodiments results.

When the rod antenna section is pulled out of the casing, the first helical section and the rod antenna section in contact therewith are fed; thus, the same advantage as in the first to third embodiments results.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna for use with a mobile station including a casing to which said antenna is attached, a radio-frequency circuit for transmitting and receiving radio-frequency signals through said antenna, a matching circuit for providing impedance matching between said radio-frequency circuit and said antenna, and a feeding terminal connected to said matching circuit for feeding said antenna, comprising:
a first antenna section having a helical portion and a first contact electrically connected with said helical portion; and
a rod-like second antenna section having its one end coupled with said first contact and provided at the other end with a second contact,
when said second antenna section is enclosed in said casing of said mobile station, said first contact faces said feeding terminal with space interposed between said first contact and said feeding terminal and is capacitive-coupled with said matching circuit, and when said second antenna section is pulled out of said casing, said second contact contacts said feeding terminal and said second contact is directly coupled with said matching circuit.

2. Said antenna according to claim 1, wherein said first contact of said first antenna section and the one end of said second antenna section are coupled by an insulating member.

3. Said antenna according to claim 1, wherein said first contact of said first antenna section and the one end of said second antenna section are electrically coupled with each other.

4. Said antenna according to claim 1, wherein said feeding terminal has a slot formed along the direction in which said antenna is moved, said first contact of said first antenna section has an outside diameter such that said first contact does not come into contact with the internal surface of the slot of said feeding terminal when said second antenna section is housed in said casing, and said second contact of said second antenna section has an outside diameter such that said second contact comes into contact with the internal surface of the slot of said feeding terminal when said second antenna section is pulled out of said casing.

5. A mobile station including a casing to which an antenna is attached; a radio-frequency circuit for transmitting and receiving radio-frequency signals through said antenna, a matching circuit for providing impedance matching between said radio-frequency circuit and said antenna, and a feeding terminal connected to said matching circuit for feeding said antenna, said antenna comprising:
a first antenna section having a helical portion and a first contact electrically connected with said helical portion; and
a rod-like second antenna section having its one end coupled with said first contact and provided at the other end with a second contact,
when said second antenna section is enclosed in said casing of said mobile station, said first contact faces said feeding terminal with space interposed between said first contact and said feeding terminal so that it is capacitive-coupled with said matching circuit, and when said second antenna section is pulled out of said casing, said second contact contacts said feeding terminal so that said second contact is directly coupled with said matching circuit.

6. Said mobile station according to claim 5, further comprising a holder fixed to said casing through which said antenna is put movably, said holder having antenna holding means for holding said antenna in two positions: one in which said first contact faces said feeding terminal when said second antenna section is housed in said casing and one in which said second contact contacts said feeding terminal when said second antenna section is pulled out of said casing.

7. Said mobile station according to claim 5, wherein said feeding terminal has a slot formed along the direction in which said antenna is moved, said first contact of said first antenna section has an outside diameter such that said first contact does not come into contact with the internal surface of the slot of said feeding terminal when said second antenna section is housed in said casing, and said second contact of said second antenna section has an outside diameter such that said second contact comes into contact with the internal surface of the slot of said feeding terminal when said second antenna section is pulled out of said casing.

8. Said mobile station according to claim 5, wherein said feeding terminal is placed in a position in a reverse direction of a direction in which said second antenna section is pulled out of said casing with respect to the position of contact of said radio-frequency circuit with said matching circuit.

9. An antenna for use with a mobile station including a casing to which said antenna is attached, a radio-frequency circuit for transmitting and receiving radio-frequency signals through said antenna, and a feeding terminal connected to said radio-frequency circuit for feeding said antenna, comprising:
a fixed antenna section fixed to protrude from said casing and having a first helical section and a second helical section with a helical center line which are arranged along the helical center line and are opposed to each other at their one end so that they are capacitive-coupled, one end of said first helical section on the opposite side from said second helical section being connected with said feeding terminal;
a rod antenna section including a metallic rod portion and a resin rod portion that are coupled together in a line, said rod antenna section being movable into or out of said casing along the helical center line of said first and second helical sections, said resin rod portion being opposed to said first helical section when said metallic rod portion is received within said casing, and an end portion of said metallic rod portion being electrically connected to an end portion of said first helical section when said metallic rod portion is pulled out from said casing.

10. A mobile station including a casing to which an antenna is attached; a radio-frequency circuit for transmitting and receiving radio-frequency signals through said antenna, and a feeding terminal connected to said radio-frequency circuit for feeding said antenna, said antenna comprising:
a fixed antenna section fixed to protrude from said casing and having a first helical section and a second helical section with a helical center line which are arranged along the helical center line and are opposed to each other at their one end so that they are capacitive-coupled, one end of said first helical section on the opposite side from said second helical section being connected with said feeding terminal;
a rod antenna section including a metallic rod portion and a resin rod portion that are coupled together in a line, said rod antenna section being movable into or out of said casing along the helical center line of said first and second helical sections, said resin rod portion being opposed to said first helical section when said metallic rod portion is received within said casing, and an end portion of said metallic rod portion being electrically connected to an end portion of said first helical section when said metallic rod portion is pulled out from said casing.
